(19) United States
(12) Patent Application Publication
(10) Pub. No.: US 2016/0026978 A1
(43) Pub. Date: Jan. 28, 2016

(54) METHOD AND DEVICE FOR AGENDA MANAGEMENT

(71) Applicant: Xiaomi Inc., Beijing (CN)

(72) Inventors: Mengying Li, Beijing (CN); Meng Xu, Beijing (CN); Wenlin Wang, Beijing (CN)

(73) Assignee: Xiaomi Inc., Beijing (CN)

(21) Appl. No.: 14/640,598

(22) Filed: Mar. 6, 2015

Related U.S. Application Data
(63) Continuation of application No. PCT/CN2014/091423, filed on Nov. 18, 2014.

(30) Foreign Application Priority Data
Jul. 23, 2014 (CN) 201410351493.3

(51) Int. Cl. G06Q 10/10

(52) U.S. Cl. CPC G06Q 10/1095

(57) ABSTRACT

The present document describes techniques for agenda management, particularly for passive events. The agenda management may include an agenda management device receiving an event notification message about a passive event. The event notification message may be received through a set interface. The event notification message may include event contents and an event occurrence time. The agenda management apparatus may generate an agenda entry according to the event contents and the event occurrence time. The event notification message may be pushed by a third party application. Thus, a reminder for the passive event may be automatically added into the agenda, without manual intervention.

This application is a continuation of International Application No. PCT/CN2014/091423, filed Nov. 18, 2014, which is based upon and claims priority to Chinese Patent Application No. 201410351493.3, filed Jul. 23, 2014, the entire contents of which are incorporated herein by reference.

### TECHNICAL FIELD

The present disclosure relates to the field of information communication, and more particularly, to a method and a device for agenda management.

### BACKGROUND

An apparatus, or device may be used for agenda management. For example, the apparatus, such as a smart terminal, may execute an agenda management application. A user of the smart terminal may set reminders for events in the agenda management application. For example, the user may set a reminder set to remind at 3:00 pm on Jul. 21, 2014, that there is a conference at 3:30 pm. The reminder may help the user not to forget the event.

There may be events that the user may not be able to predict, or are hidden from the user, and thus the user may not be able to plan for. Hence, the user may not be able to set a reminder about such events into the agenda management application. For example, such hidden events may include a change of weather that necessitates an umbrella, or a drop in price of an item in a shopping cart of a shopping website. Such hidden events may be monitored by corresponding third party applications, which may remind the user using a notification bar. For example, a weather application may monitor change of weather and publish a weather change notification in the notification bar; a shopping application may monitor price of an item and publish a price drop notification in the notification bar.

### SUMMARY

The present disclosure provides a method, a device, an apparatus, and a system for agenda management.

According to a first aspect a method for agenda management may include receiving an event notification message via an interface. The event notification message may include a description and an occurrence time of an event. A processor may generate an agenda entry according to the description and the occurrence time. The processor may add the agenda entry to an agenda. The event may be a passive event like a natural phenomenon such as a weather change. Alternatively or in addition, the event may be a change in a website such as a change in a price of an item on an online retail website, or a new item available for sale on the online retail website.

According to a second aspect a device or an apparatus for agenda management, may include a processor and a memory for storing instructions executable by the processor. The processor may receive an event notification message through an interface. The event notification message may include a description and an event occurrence time of an event. The processor may generate a meeting request according to the description and the event occurrence time. The processor may further send the meeting request to an account associated with a user, such as an email account that may trigger adding an agenda item to the user's agenda.

According to a third aspect a non-transitory readable storage medium comprising instructions, executable by a processor in a terminal, for performing a method for agenda management. The method may include receiving an event notification message through a predetermined interface. The event notification message may include a description and an occurrence time of an event. The method may further include generating an agenda memo according to the description and the occurrence time. Further yet, the method may include identifying a transmitter of the event notification message, and searching a registration list of the predetermined interface for the transmitter of the event notification message. A type of the event notification message may be identified if the transmitter is listed in the registration list. If the transmitter is not listed in the registration list or if the determined type of the event notification message is not a preselected type, the agenda memo is not generated, and instead a failure message may be sent to the transmitter.

It is to be understood that both, the foregoing general description and the following detailed description are exemplary and explanatory only and are not restrictive of the present disclosure.

### BRIEF DESCRIPTION OF THE DRAWINGS

The accompanying drawings herein, which are incorporated into and constitute a part of the specification, illustrate embodiments consistent with the present disclosure, and together with the specification, serve to explain the principles of the present disclosure. The components in the figures are not necessarily to scale.

FIG. 1 is a flow chart showing a method for agenda management, according to an exemplary embodiment;

FIG. 2 is a flow chart showing a method for agenda management, according to an exemplary embodiment;

FIG. 3 is a block diagram showing a user interface to set a registration list, according to an exemplary embodiment;

FIG. 4 is a block diagram showing a predetermined time period setting user interface, according to an exemplary embodiment;

FIG. 5 is a block diagram showing a device for agenda management, according to an exemplary embodiment;

FIG. 6 is a block diagram showing a device for agenda management, according to an exemplary embodiment;

FIG. 7 is a block diagram showing a structure of a receiving module, according to an exemplary embodiment;

FIG. 8 is a block diagram showing a structure of a generation module, according to an exemplary embodiment;

FIG. 9 is a block diagram showing a structure of an authorization module, according to an exemplary embodiment; and

FIG. 10 is a block diagram showing a device for agenda management, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description are exemplary embodiments and do not represent all possible implementations. Instead, they are merely examples of apparatus and methods consistent with some aspects as recited in the appended claims.

FIG. 1 is a flow chart showing a method for agenda management, according to an exemplary embodiment. An apparatus, a device, or a terminal may perform the steps in the method for agenda management. An agenda may be a tool used by a user of the apparatus to manage time and stay organized. The agenda may be a calendar, a to-do list, or any other type of a collection of events for a user of the apparatus to do, attend to, or handle. For example, the agenda for a particular day may be a collection of items that the user may prefer to do, or attend to on that particular day. In other examples, an agenda may be for a week, a month, a year, or any other duration of time.

An entry in the agenda may also be referred to as an agenda entry. The agenda entry may be associated with an event such as a conference call, a meeting, or the like. The agenda entry may be a meeting request, a to-do list item, a calendar entry, or any other agenda item of an agenda management application of the agenda management apparatus. For example, if the agenda management apparatus uses a calendar for agenda management, the agenda entry may be a calendar entry. Alternatively or in addition, if the agenda management apparatus uses a task list to maintain an agenda, the agenda entry may be a task item.

The agenda entry may help remind the user about the corresponding event. The event may or may not be associated with a time duration, or a timeslot. Accordingly, the corresponding agenda entry may or may not be associated with the time duration. The time duration may include a start-time and an end-time. For example, a meeting scheduled from 2:00 PM to 3:00 PM, or an item being priced at a lower price between 1:00 PM to 3:00 PM. In an example the agenda entry may be associated with a start-time only. For example, an agenda entry to pick an umbrella before leaving. The agenda entry may be associated with a reminder. The reminder may alert the user of the event. The alert may be provided some time before the event is scheduled to start. The alert may be provided X minutes before the start-time, where X may be a system default or predetermined by the user.

The event may be a hidden, or passive event. A passive event may be an event that the user may not be able to change, or may not be in a position to influence. The passive event may be unchangeable. For example, a natural phenomenon, or an act of nature, such as a weather change. In another example, the passive event may be beyond the user's control, such as an event that a third party may cause to occur without any action, or input of the user. For example, a change in content of a website such as a retailer's website may a change a price of an item such as a cruise; or a television channel may change screening time of a television program. As opposed to a passive event, the user may be able to influence what may be referred to as an active event. For example, a user may able to reschedule a meeting, thus influencing the meeting (i.e. event).

Further, the user may not be able to monitor a passive event continuously. For example, the user may not actively monitor the weather. As a result, the user may not be aware of an upcoming change in the weather, such as an upcoming rain-shower (a passive event). However, the user may register with a service provider that sends event notification messages regarding changes in weather. The agenda management apparatus may receive the event notification message regarding the passive event, such as the change in weather, from the service provider and automatically create a corresponding agenda entry, such as to carry an umbrella, based on the time of the rain-shower forecast. Additional examples of a passive event may include an upcoming concert, movie, play, television program screening, sporting event, or the like that the user may choose to receive an event notification message about. A passive event may also be a change in a website, a change in price of an item, such as a consumer good, an appliance, a travel ticket, or the like that the user may have added to an online shopping cart, or wish list. Other examples of a passive event may include change in schedules of a train, a bus, a ferry, a plane, and/or a change in traffic conditions. The above examples of passive events are non-limiting and the agenda management apparatus may handle several other examples of passive events as described throughout the present document.

The examples below describe automatic agenda management in response to passive or hidden events. Accordingly, unless specifically noted, an ‘event’ in the following examples refers to a passive event. For example, the agenda management apparatus may execute an agenda management application that performs a method for managing the agenda. The method may include at least the following steps.

In step 11, the agenda management apparatus may receive an event notification message. The event notification message may be received through, via, or at an interface of the agenda management apparatus. The event notification message may include event contents and an event occurrence time. The event may be a hidden event, a passive event, or a masked event that the user is not actively monitoring. The event contents may be a description of the event. The event occurrence time may include a date, a day of the week, a specific time. In another example, the event occurrence time may include a reference of a time duration, such as “tomorrow morning,” or “next week,” or “next Thursday,” or other such reference.

In step 12, the apparatus may generate an agenda entry. In an example, the agenda entry may be generated using a memo. For example, a memo such as a meeting invitation may be sent to an email application of the apparatus, and an agenda entry created and added to the agenda in response to the memo being received or opened. In another example, the agenda entry may be created and added to the agenda; without the email application. The agenda entry may be based on the event contents and the event occurrence time.

In an example, a transmitter, such as a third party application may push the event notification message for receipt by the agenda management apparatus. The agenda management apparatus may receive the event notification message without any user intervention. The agenda management apparatus may generate the agenda entry in response to, and according to the event notification message. The agenda management apparatus may also create a reminder corresponding to the agenda entry. The user, thus, may not have to add a reminder into the agenda management manually. Accordingly, the method may implement automatic agenda management, and thus time management, for the user.

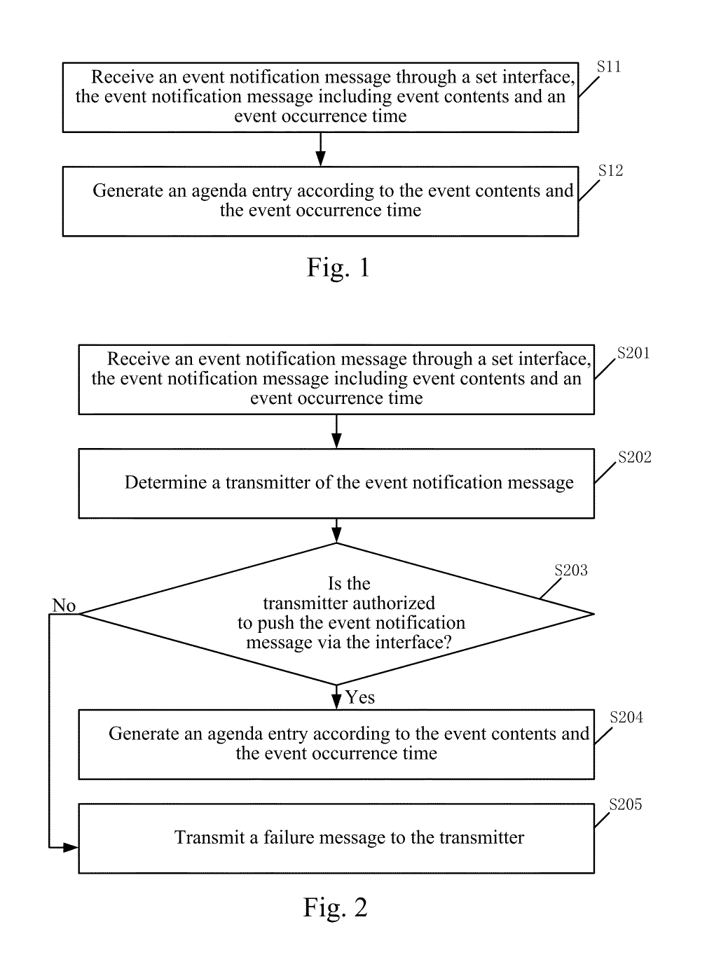

FIG. 2 is a flow chart showing an agenda management, according to an exemplary embodiment. An agenda management apparatus, a device, or a terminal may perform the steps in the method illustrated. For example, the agenda management apparatus may execute an agenda management application that includes corresponding operations to perform the method. The method may include at least the following steps.

In step 201, an interface of the agenda management apparatus may receive the event notification message. The event notification message may include event contents and an event occurrence time.

The interface at which the event notification message is received may be preset, or predetermined. The interface may be referred to as a set interface. The transmitter, such as the third party application may push the event notification message by calling the interface. For example, the third party application may be aware of an identity of the interface to which the event notification message is to be pushed. The transmitter may direct communication to the interface based on the identity of the interface. For example, the identity of the interface may be a port address, a memory address, a network address (such as an Internet Protocol (IP) address), a phone number, a username, or any other identifier that may be used by the transmitter to push, or send the event notification message. For example, the transmitter may push the event management notification to a preset phone number that identifies the interface, such as via a text message. In another example, the transmitter may push the event management notification to a preset IP address of the interface. The agenda management apparatus, in response to receipt of the event notification message, may trigger further operations as described throughout the present document.

The interface may have a fixed, or a predetermined message format. After the event notification message is received, the received event notification message may be transformed into the predetermined message format.

The event contents in the event notification message may be different based upon different transmitters. For example, the event contents in a first event notification message may indicate a change in weather, while the event contents in a second event notification message may indicate a drop in price of an item in a shopping cart.

In step 202, a transmitter of the event notification message is determined. For example, the transmitter may be the third party application, a server, an aggregator, or any other entity that sends the event notification message directed to the interface of the agenda management apparatus. In an example, a server that stores weather information may send a weather related event notification message directed to the interface. In another example, an e-commerce server may send an event notification message related to an item to the interface.

In yet another example, an aggregator, which may be a server that aggregates information from multiple sources, may send an event notification message associated with information that the user has indicated interest in. For example, the user may have identified a television program, a music group, a consumer good or an item on sale, or any other information that might be of interest. In an example, a media server may send an event notification message to the set interface indicating a new episode, or a rerun of an episode of the identified television program at a scheduled time. Alternatively or in addition, the server may send an event notification message related to a live event of the identified music group. In an example, an application corresponding to the transmitting server may generate and forward the event notification message to the interface. For example, in the above weather related scenario, a weather application may execute on the weather server, the agenda management apparatus itself, or any other communication device. The application may identify the change in weather and send the event notification message to the interface. While the weather application is described in this example, a third party application may send an event notification message in case of any other passive event. The third party application may be considered a transmitter in such cases. Alternatively or in addition, the server or hardware executing the third party application may be considered the transmitter.

The transmitter may add identity information to the event notification message. The identity information may be an identity label or any other identifier, based upon which the transmitter of the event notification message may be determined. For example, the identity information may be a name, an IP address, a phone number, a digital certificate, a digital signature, or any other identification mark that may associate the event notification message to the transmitter. For example, transmitter may send a digital signature with the event notification message. The digital signature may be unique to the transmitter. The transmitter may send the identification mark as part of the event notification message. Alternatively or in addition, the transmitter may send the identification mark separate from the event notification message. Alternatively or in addition, the transmitter may be identified based on a IP address, a Media Access Control (MAC) address, a port address, a memory address, or the like that may be associated with the transmitter.

The interface identifier, such as an interface address, may be provided to the transmitter. The transmitter may, thus, know and use the interface address to push the event notification message for receipt by the agenda management apparatus. For example, the transmitter may store the interface identifier. Alternatively or in addition, the transmitter may access the interface identifier from a stored location.

In step 203, the agenda management apparatus may determine an authorization of the transmitter to push the event notification message via the interface. If the transmitter is allowed to push the event notification message via the interface, step 204 is performed; otherwise, step 205 is performed.

The interface may be a filter that filters event notification messages received at the interface. The interface may, thus, allow only event notification messages from selected transmitters to be processed by the agenda management apparatus. The agenda management apparatus may determine whether the transmitter is allowed to push the event message to the agenda management apparatus via the interface as described in the following examples.

In an example, the interface may be associated with the transmitter before receiving communication from the transmitter. For example, the interface may have a corresponding registration list. The registration list may associate, or link, the interface with the transmitter. For example, the registration list may contain information such as labels of a registered transmitter, such as a third party application. Further, the transmitter may register each type of event notification message the transmitter may push to the interface. For example, if the transmitter is a third party shopping application, the transmitter may register a first type of entry for an event notification message associated with item price and a second type of entry associated with new product event notification message.

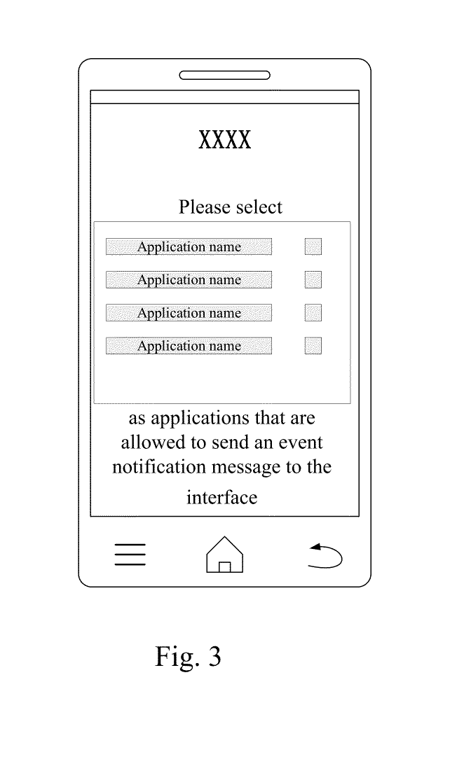

The user of the agenda management apparatus may set the registration list of the interface. FIG. 3 is a block diagram showing an example user interface to set the registration list. As shown in FIG. 3, the user may select, from among multiple applications that may be installed in an operating system of the apparatus, the applications that are allowed to push the event notification message to the interface.

When determining, or identifying whether the transmitter is allowed to push the event notification message, the apparatus may determine whether the transmitter of the event notification message is located in the registration list of the interface. If the transmitter is located in the registration list of the interface, the apparatus may further determine whether a type of the received event notification message is one of the types of entries that are registered by the transmitter. If the received event notification message is of a type that is registered by the transmitter, then the transmitter is determined as being allowed to push the event notification message via the interface. Thus, interface may filter event notification messages received at the interface. An event notification message received from a transmitter that is not registered with the interface may be rejected, while an event notification message received from a registered transmitter may be further analyzed. For example, the event notification message from a registered transmitter may be rejected if the event notification message is of a type that is not registered with the interface.

In step 204, the agenda management apparatus may generate a memo agenda, or an agenda entry according to the event contents and the event occurrence time.

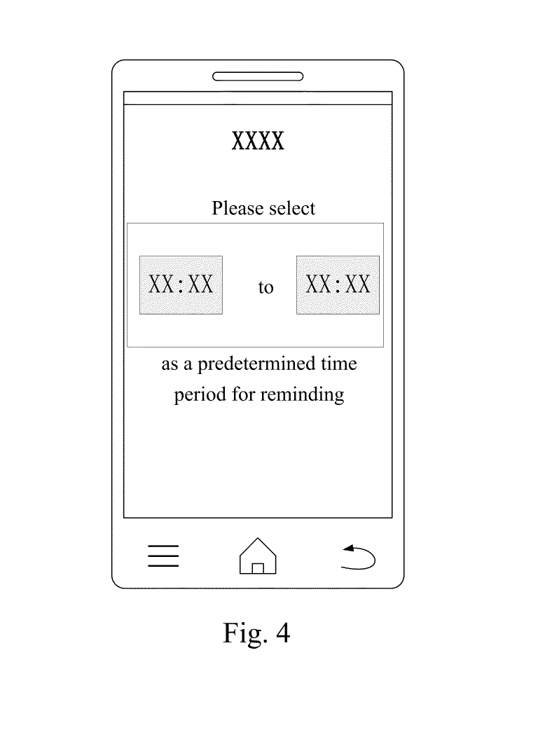

The event contents may be stored in an agenda management application. For example, the event contents may be stored in an agenda of a date corresponding to the event occurrence time. The agenda management apparatus may further generate and set a reminder that may notify the user a predetermined time period before the event occurrence time. For example, the agenda management apparatus may notify the user within the predetermined time period by vibrating, ringing, or the like. The predetermined time period may be set by the user. Alternatively, the predetermined time period may be a system default. FIG. 4 is a block diagram showing an example user interface to set the predetermined time period. As shown in FIG. 4, the user may set the predetermined time period through such an interface.

In step 205, if the transmitter is not allowed to send an event notification message to the interface, the agenda management apparatus may send feedback, or message to the transmitter indicating failure of the event notification message being transmitted.

An example is presented hereinafter by using a third party application as a transmitter that forecasts weather and transmits a related event notification message to the agenda management apparatus. The agenda management apparatus itself may be executing the weather application. Alternatively or in addition, the weather application may be executing on a separate apparatus that can transmit the event notification message to the agenda management apparatus. It is supposed that the weather application has already registered with the set interface, such as by following the steps described throughout the present document. Further, assume that the current time is 7:00 pm, and that the weather application monitors that there will be moderate rain tomorrow morning. The weather application may call upon the set interface, and push an event notification message carrying a description that “there will be moderate rain” and “tomorrow morning.” The agenda management apparatus in response, may determine whether the weather application is allowed to push the event notification message via the set interface. Upon confirmation of the authorization, the agenda management apparatus may store the event contents “there will be moderate rain” into the agenda of the date corresponding to the event occurrence time “tomorrow morning” in the agenda management application. Thus, in this example, the apparatus may store the event contents in the agenda of tomorrow, and finally set a reminder event at 8:00 am of tomorrow. The time 8:00 am may be selected as a default or based on the user selection via the predetermined time setting user interface.

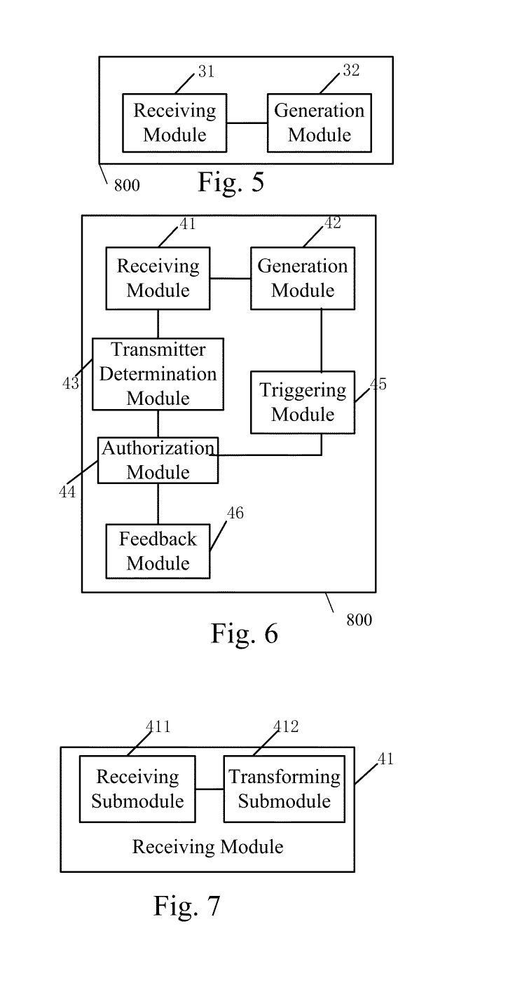

FIG. 5 is a block diagram showing a device, a terminal, or an apparatus for agenda management, according to an exemplary embodiment. Referring to FIG. 5, the apparatus 800 may include components, units, or modules such as a receiving module 31 and a generation module 32. The apparatus 800 may include more, fewer, or different modules, elements, or components than those illustrated in FIG. 5. The apparatus 800 may be a communication apparatus such as a mobile phone, a smart phone, a personal digital assistant, a camera, a media player (such as iPod, Walkman, or any other), a tablet computer, a laptop, a desktop, or any other type of communication apparatus.

The receiving module 31 may receive an event notification message through an interface. The event notification message may include event contents and an event occurrence time. The receiving module 31 may preset, preselect, or predetermine the interface at which the event notification message is received. The transmitter, such as the third party application may push the event notification message via the preset interface. For example, the transmitter may identify the interface to which the event notification message is to be pushed. The interface may be a communication interface or an identity or address to which the transmitter may direct communication. For example, the interface may be a port address, or a memory address, a network address (such as an IP address), a phone number, or any other identifier that the transmitter may use to push, or send the event notification message to the receiving module 31. The interface may be referred to as a set interface.

The generation module 32 may generate an agenda entry according to the event contents and the event occurrence time.

In an example, a transmitter may push, or send the event notification message via the interface. The agenda entry may be generated according to and in response to receipt of the event notification message. A user of the apparatus 800 may not have to intervene, or take any actions at this time, to create and/or add the agenda entry into the agenda management. Thus the apparatus 800 may manage an agenda for the user and help organize a schedule, or calendar for the user.

FIG. 6 is a block diagram showing a device, a terminal, or an apparatus for agenda management, according to an exemplary embodiment. Referring to FIG. 6, the apparatus 800 may include components, units, or modules such as a receiving module 41, a generation module 42, a transmitter determination module 43, an authorization module 44, a triggering module 45, and a feedback module 46. The apparatus 800 may include more, fewer, or different modules, elements, or components than those illustrated in FIG. 6.

The receiving module 41 may receive the event notification message through the interface.

As shown in FIG. 7, the receiving module 41 may include subcomponents, subunits, and submodules, such as a receiving submodule 411 and a transforming submodule 412.

The receiving submodule 411 may receive the event notification message through the interface.

The transforming submodule 412 may transform the event notification message from one format to another. For example, the apparatus 800 may process information in a particular format to generate an agenda entry. However, the transmitter may send the event notification message in a different format. Moreover, different transmitters may have their own message formats. The transforming submodule 412 may transform the received event notification message into the format used by the apparatus 800. The contents of the received and transformed event notification message may be used by the other components of the apparatus 800.

The triggering module 45 may trigger the generation module 42 upon the transformation of the event notification message. If the event notification message is already in the format used by the apparatus 800, the triggering module 45 may trigger the generation module 42 upon receipt of the event notification message. The generation module 42, in response to the trigger, may generate an agenda entry. The agenda entry may be a meeting request, an agenda memo, or any other type of agenda entry. For example, the agenda memo or meeting request created may be for an e-mail application. The agenda memo may be, additionally, forwarded to the user's email-id or email application. The generation module 42 may generate the agenda entry according to the event contents and the event occurrence time in the received event notification message.

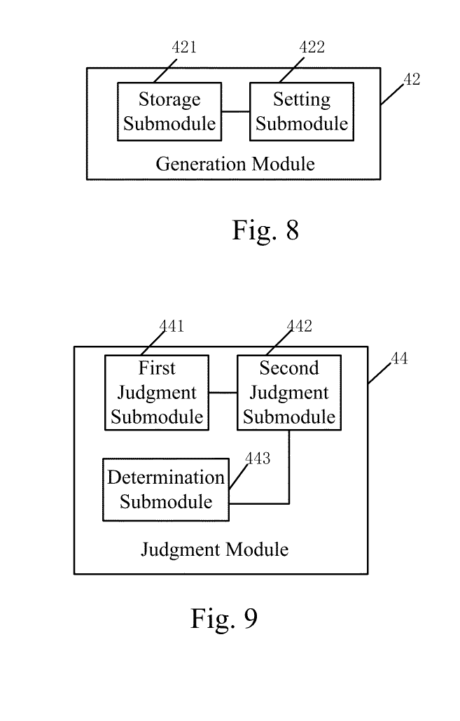

As shown in FIG. 8, the generation module 42 may include subcomponents, subunits, and submodules, such as a storage submodule 421 and a setting submodule 422.

The storage submodule 421 may store the event contents in the agenda of a date corresponding to the event occurrence time. The setting submodule 422 may set a reminder event within a predetermined time period before the event occurrence time.

The transmitter determination module 43 may determine a transmitter of the event notification message. The transmitter determination module 43 may identify the transmitter based on an identity information that may be part of the event notification message, or alternatively received in conjunction with the event notification message. For example, the identity information may be a digital signature, a digital certificate, or any other information that indicates the transmitter's identity. Alternatively or in addition, the transmitter determination module 43 ma identify the transmitter based on an IP address, a MAC address, a port address, a memory address, or any other information that may be associated with the source of the received event notification message.

The authorization module 44 may determine whether the transmitter is authorized, or allowed to send or push the event notification message to the interface.

In an example shown in FIG. 9, the authorization module 44 may include subcomponents, subunits, and submodules, such as a first submodule 441, a second submodule 442 and a determination submodule 443.

The first submodule 441 may determine whether the transmitter is listed in a registration list of the interface. The interface may have a corresponding registration list. The registration list may be created by the user, such as by using the user interface illustrated in FIG. 3. The registration list may contain identities of transmitters that are allowed to transmit an event notification message to the interface. If an identity of a transmitter is not listed in the registration list, an event notification message from that transmitter may not be processed, or analyzed by the components of the apparatus 800. A corresponding rejection, or failure message may be sent to the transmitter.

The second submodule 442 may determine whether the transmitter has identified the event notification message as a notification to be pushed to the apparatus 800. The registration list may further identify types of event notification messages from a transmitter that may be analyzed. For example, event notification messages that indicate a price drop may be a type of event notification message that may be analyzed. Further, event notification messages that indicate availability of a new product may not be a type of event notification message for further analysis. Accordingly, if a shopping application in the registration list pushes a first event notification message indicating a price drop of an item and a second event notification message indicating availability of a new product, the second submodule 442 may determine that the former as authorized and the latter as unauthorized. In an example, the second submodule may analyze the event notification message if the first submodule 441 determines that the transmitter is in the registration list of the interface. The user may select the types of event notification messages that are to be analyzed and for which agenda entries are to be created.

The determination submodule 443 may determine that the transmitter is allowed to use the interface to push the event notification message. In an example, the determination submodule 443 makes the determination if the first submodule 441 confirms that the transmitter is in the registration list of the interface and the second submodule 442 confirms that the event notification message is of a type that is to be analyzed.

The triggering module 45 may trigger the generation module 42 to perform operations when the authorization module 44 determines that the transmitter is allowed to push the event notification message via the interface.

The feedback module 46 may transmit a feedback to the transmitter. For example, if the authorization module 44 determines that the transmitter is prohibited, or not allowed to push the event notification message via the interface, the feedback module 46 may send a feedback message to the transmitter. The feedback message may indicate that pushing the event notification message to the transmitter failed.

The apparatus 800 may be implemented in many different ways. Each module, component, element, unit, such as the generation module 42, the transmitter determination module 43, the authorization module 44, the triggering module 45, and the feedback module 46, and their respective submodules and subunits described throughout this document, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively or in addition, each module may include memory hardware, such as a portion of a memory, for example, that comprises instructions executable with a processor to implement one or more of the features of the module. When any one of the module includes the portion of the memory that comprises instructions executable with the processor, the module may or may not include the processor. In some examples, each module may just be the portion of a physical memory that comprises instructions executable with one or more processors to implement the features of the corresponding module without the module including any other hardware. Because each module includes at least some hardware even when the included hardware comprises software, each component may be interchangeably referred to as a generation hardware, a transmitter determination hardware, an authorization hardware, a triggering hardware, and a feedback hardware.

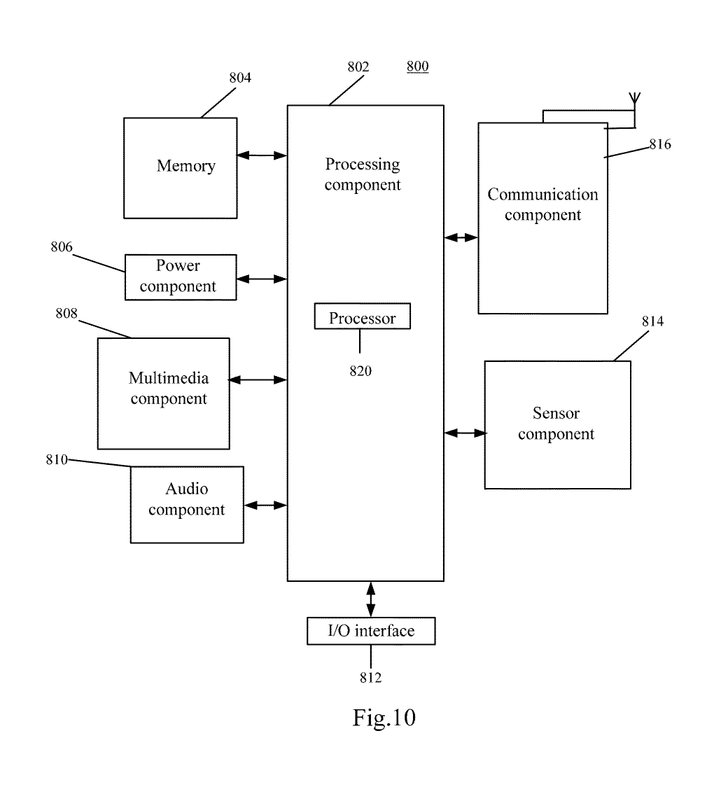

FIG. 10 is a block diagram showing a device, a terminal, or an apparatus 800 for agenda management, according to an exemplary embodiment. For example, the apparatus 800 may be a mobile phone, a computer, a digital broadcast terminal, a messaging device, a gaming console, a tablet, a medical device, exercise equipment, a personal digital assistant, and the like.

Referring to FIG. 10, the apparatus 800 may include one or more of the following components: a processing component 802, a memory 804, a power component 806, a multimedia component 808, an audio component 810, an input/output (I/O) interface 812, a sensor component 814, and a communication component 816.

The processing component 802 may control overall operations of the apparatus 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 may store various types of data to support the operation of the apparatus 800. Examples of such data include instructions for any applications or methods operated on the apparatus 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 may provide power to various components of the apparatus 800. The power component 806 may include a power management system, one or more power sources, and any other components associated with the generation, management, and distribution of power in the apparatus 800.

The multimedia component 808 includes a screen providing an output interface between the apparatus 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the apparatus 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the apparatus 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the apparatus 800. For instance, the sensor component 814 may detect an open/closed status of the apparatus 800, relative positioning of components, e.g., the display and the keypad, of the apparatus 800, a change in position of the apparatus 800 or a component of the apparatus 800, a presence or absence of user contact with the apparatus 800, an orientation or an acceleration/deceleration of the apparatus 800, and a change in temperature of the apparatus 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the apparatus 800 and other devices. The apparatus 800 may access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods. For example, the processing component 802 may be a central processor of the apparatus 800 responsible for execution of an operating system, control instructions, and applications installed on the apparatus 800. The processing component 802 may be one or more devices operable to execute logic. The logic may include computer executable instructions or computer code embodied in the memory 804 or in other memory that when executed by the processing component 802, cause the processing component 802 to perform the features implemented by the logic. The computer code may include instructions executable with the processing component 802. The computer code may include embedded logic. The computer code may be written in any computer language now known or later discovered, such as C++, C#, Java, Pascal, Visual Basic, Perl, HyperText Markup Language (HTML), JavaScript, assembly language, shell script, or any combination thereof. The computer code may include source code and/or compiled code. The processing component 802 may be a general processor, central processing unit, server, ASIC, digital signal processor, FPGA, digital circuit, analog circuit, or combinations thereof. The processing component 802 may be in communication with the memory 804 and the other components of the apparatus 800.

In exemplary embodiments, there is also provided a non-transitory computer-readable storage medium including instructions, such as included in the memory 804, executable by the processor 820 in the apparatus 800, for performing the above-described methods. For example, the non-transitory computer-readable storage medium may be a ROM, a RAM, a CD-ROM, a magnetic tape, a floppy disc, an optical data storage device, and the like.

As used throughout the present document, a second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are to be construed in the broadest sense, superseding any other implied definitions hereinbefore or hereinafter unless expressly asserted to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

Other embodiments will be apparent to those skilled in the art from consideration of the specification. This application is intended to cover any variations, uses, or adaptations following the general principles described throughout the present document including such departures from the present disclosure as come within known or customary practice in the art. It is intended that the specification and examples be considered as exemplary only.

It will be appreciated that the exact construction that has been described above and illustrated in the accompanying drawings is exemplary, and that various modifications and changes can be made without departing from the scope thereof

What is claimed is:

1. A method for agenda management, comprising:
receiving an event notification message via an interface, the event notification message comprising a description and an occurrence time of a passive event;
generating, by a processor, an agenda entry according to the description and the occurrence time; and
adding, by the processor, the agenda entry for the passive event to an agenda.

2. The method of claim 1, further comprising:
determining, by the processor, a transmitter of the event notification message;
determining, by the processor, an authorization of the transmitter to send the event notification message via the interface; and
in response to determining that the transmitter is allowed to send the event notification message via the interface, generating the agenda entry according to the description and the occurrence time of the event.

3. The method of claim 2, further comprising:
transmitting, by the processor, a failure message directed to the transmitter in response to the transmitter being prohibited send the event notification message via the interface.

4. The method of claim 2, wherein, determining the authorization of the transmitter to send the event notification message comprises:
identifying, by the processor, the transmitter being in a registration list of the interface;
in response to the transmitter being in the registration list of the interface, determining that the event notification message is a selected type of event notification message; and
in response to the event notification message being a selected type of event notification message, determining the transmitter as being authorized to send the event notification message via the interface.

5. The method of claim 1, wherein, receiving the event notification message via the interface comprises:
transforming the event notification message into a predetermined format.

6. The method of claim 1, wherein, generating the agenda entry according to the description and the occurrence time of the passive event comprises:
storing the description into an agenda of a date corresponding to the occurrence time; and
setting a reminder for a time that is a predetermined time period before the occurrence time.

7. An apparatus for agenda management, the apparatus comprising:
a processor; and
a memory for storing instructions executable by the processor;
wherein the processor is configured to:
receive an event notification message through an interface, the event notification message comprising description and an event occurrence time of a passive event, wherein the event occurrence time of the passive event cannot be changed by the apparatus; and
generate a meeting request according to the description and the event occurrence time.

8. The apparatus of claim 7, wherein the processor is further configured to:
determine a transmitter of the event notification message;
determine whether the transmitter is allowed to push the event notification message through the interface; and
send a trigger in response to determination that the transmitter is allowed to push the event notification message through the interface.

9. The apparatus of claim 8, wherein the processor is further configured to:
transmit a failure message to the transmitter in response to determination that the transmitter is not allowed to push the event notification message through the interface.

10. The apparatus of claim 8, wherein the processor is further configured to:
determine whether the transmitter is identified in a registration list of the interface;
determine whether the event notification message is of a predetermined type; and
determine that the transmitter is allowed to push the event notification message through the interface in response to the transmitter being identified in the registration list of the interface and the event notification message being of the predetermined type.

11. The apparatus of claim 7, wherein the processor is further configured to:
receive the event notification message through the interface; and
transform the event notification message into a set format.

12. The apparatus of claim 7, wherein the processor is further configured to:
store the description in the meeting request for a date corresponding to the event occurrence time; and
set a reminder event within a predetermined time period before the event occurrence time.

13. The apparatus of claim 7, wherein the event notification message is for a natural phenomenon.

14. The apparatus of claim 7, wherein the event notification message identifies a change in a website.

15. A non-transitory readable storage medium comprising instructions, executable by a processor in a terminal, for performing a method for agenda management, the method comprising:
receiving an event notification message through a predetermined interface, the event notification message comprising a description and an occurrence time of an event that is unchangeable; and
generating an agenda memo according to the description and the occurrence time.

16. The non-transitory readable storage medium of claim 15, wherein the event is a change in weather.

17. The non-transitory readable storage medium of claim 15, the method further comprising:
identifying a transmitter of the event notification message;
searching a registration list of the predetermined interface for the transmitter of the event notification message; and
in response to the transmitter not being in the registration list, sending a failure message to the transmitter of the event notification message.

18. The non-transitory readable storage medium of claim 15, wherein the event notification message received is a first event notification message, the first event notification message is of a first type, and the method further comprises:
receiving a second event notification message, wherein the second event notification message is of a second type;
in response to the first event notification message being of the first type, generating the agenda memo according to the first event notification message; and
in response to the second event notification message being of the second type, rejecting the second event notification message.

19. The non-transitory readable storage medium of claim 18, wherein the first event notification message and the second event notification message are received from the same transmitter.

20. The non-transitory readable storage medium of claim 19, wherein the method further comprises:
sending a failure message to the transmitter in response to the second event notification message being of the second type.
